(19) United States
(12) Patent Application Publication
(10) Pub. No.: US 2026/0162502 A1
(43) Pub. Date: Jun. 11, 2026

(54) SYSTEMS AND METHODS FOR LOTTERY GAME PLAY OVER MOBILE NETWORKS USING A MOBILE ACCOUNT

(71) Applicant: OnePIN, Inc., Westborough, MA (US)

(72) Inventors: Feyzi CELIK, Hopkinton, MA (US); Chris DEGRACE, Hopkinton, MA (US); Andrea GOODWIN, Fryeburg, ME (US); Marcin NOWAK, Westborough, MA (US)

(73) Assignee: OnePIN, Inc., Westborough, MA (US)

(21) Appl. No.: 18/707,722

(22) PCT Filed: Nov. 7, 2021
(86) PCT No.: PCT/US2021/058369

§ 371 Date: May 6, 2024

(51) Int. Cl. G07F 17/32; G06Q 20/08

(52) U.S. Cl. CPC G07F 17/329; G07F 17/3218; G07F 17/3255; G06Q 20/085

(57) ABSTRACT

A mobile lottery service and system allows users to play a lottery on a mobile device using their available mobile airtime, eliminating the need for a credit card or a bank and expanding gameplay to a larger base. The mobile lottery service is frictionless to users because it is provided as an embedded solution on the SIM card within a mobile device. Because the software application that enables the mobile lottery service is embedded in the Mobile Operator Network, the user also does not need to have a data plan to play. By allowing users to play on a one-time or subscription basis in addition to prompting users with multiple different games and prices, the mobile lottery service offers a less expensive and more flexible solution when compared to existing market alternatives.

### FIELD

This disclosure relates to the field of gaming, and specifically, to methods and systems for lottery game play over mobile networks.

### BACKGROUND

In many countries, people are prevented from playing lottery games due to the fact that they do not have a credit card or are “unbanked”—meaning they do not have bank access or a bank account. Often, lottery games are played through a web interface, which requires a credit card or a linked bank account. Game play via mobile USSD (Unstructured Supplementary Service Data) could also be an option but requires a linked bank account or a link to a mobile money application (which in turn is linked to a designated bank account). Often, the chances of winning in these types of lotteries are low, which discourages gameplay. Therefore, there is a need for a way of playing the lottery that is secure, offers a greater chance of winning, and offers more flexible payment options to participants compared to traditional lottery processes.

### SUMMARY

One aspect of this disclosure is directed to a system for playing a lottery game on a mobile operator's network. The system comprises an Engagement Cloud Server operably connected to the mobile operator's network and configured to: send a recruitment message to a plurality of mobile devices connected to the mobile operator's network, the recruitment message comprising: an invitation to play a lottery game; a first actionable option to accept the invitation; and a second actionable option to decline the invitation, wherein the recruitment message is configured to be displayed on a screen of a mobile device. The Engagement Cloud server is also configured to collect one or more responses to the recruitment message, wherein each response comprises a Mobile Station International Subscriber Directory Number (“MSISDN”) and an indication whether the first actionable option accepting the invitation or the second actionable option declining the invitation was selected on a mobile device associated with the MSISDN. The Engagement Cloud server is also configured to send a communication to a Gaming Engine Server comprising a first MSISDN of a first mobile device and a first actionable option selected on the first mobile device.

The system also comprises a Gaming Engine Server operably connected to the Engine Cloud Server and the mobile operator's network, the gaming engine server configured to: send game content to the first mobile device, the game content comprising a game choice and a cost to play; receive a response message comprising the first MSISDN of the first mobile device, game choice selected on the first mobile device, and mobile device lottery numbers selected on the first mobile device; draw winning lottery numbers or retrieve winning lottery numbers from an established lottery; determine whether the mobile device lottery numbers match the winning lottery numbers; send a winning notification to the first mobile device if the mobile device lottery numbers match the winning lottery numbers, the winning notification comprising a prize amount; and send the prize amount to the Operator Mobile Money Server. In some embodiments, the Gaming Engine Server is configured to receive a plurality of response messages from a plurality of mobile devices and is configured to organize the response message according to the game choices selected.

The system also comprises an Operator Billing Server configured to: access a mobile subscriber account associated with the first MSISDN; determine whether the mobile subscriber account has sufficient funds to pay for the game choice selected on the first mobile device; send a communication to the Gaming Engine Server or the Engagement Cloud server, or both, indicating the mobile subscriber account has sufficient funds to pay for the game choice selected on the first mobile device.

The system also comprises an Operator Mobile Money Server configured to receive a prize amount from the Gaming Engine Server and credit the prize amount to a prize account associated with the first MSISDN.

In the system, the Engagement Cloud Server, Gaming Engine Server, Operator Billing Server, and Operator Mobile Money Server are operably connected to the mobile operator network. In some embodiments, the Engagement Cloud Server, Gaming Engine Server, Operator Billing Server, and Operator Mobile Money Server are operably connected to each other.

In some embodiments, the system also comprises a mobile gaming application installed on a SIM of the first mobile device, the mobile gaming application configured to: display content received from the Gaming Engine Server on a screen of the first mobile device; receive an option selected on the screen of the first mobile device; and send an application message comprising the option selected to the Gaming Engine Server.

Another aspect of this disclosure is directed to a method for providing lottery gameplay to a mobile device in a gaming system comprising a gaming engine server, an engagement cloud server, an operator billing server, and an operator mobile money server. The mobile device and the gaming system are operably connected to a mobile operator's network. The method comprises the steps of: sending, from the engagement cloud server, a recruitment message to be displayed on a screen of a mobile device, the recruitment message comprising an invitation to play a lottery game and an actionable option to accept the invitation; sending, from the engagement cloud server to the gaming engine server, a communication comprising the MSISDN of the mobile device; sending, from the gaming engine server to the mobile device, a first gaming message comprising a game choice and a cost to play; upon receipt of a game choice selected on the mobile device, sending, from the gaming engine server to the mobile device, a second gaming message comprising an option to input lottery numbers and an option to select lottery numbers; upon receipt of inputted or selected lottery numbers, sending, from the gaming engine server to the mobile device, a confirmation message comprising contents confirming the inputted or selected lottery numbers and the cost to play; at the gaming engine server, generating winning lottery numbers or retrieving winning lottery numbers from an established lottery; and determining whether the inputted or selected lottery numbers match the winning lottery numbers.

In some embodiments, the method further comprises sending, from the gaming engine server to the operator billing server, an inquiry to determine sufficiency of funds to pay the cost to play; determining, at the mobile operator billing server, whether a mobile account associated with the mobile device has sufficient funds to pay the cost to play; and sending, from the mobile operator billing server to the gaming engine server, a funds confirmation message indicating the mobile account has sufficient funds to pay the cost to play.

In some embodiments, the method further comprises sending a notification from the gaming engine server to the mobile device indicating the inputted or selected lottery numbers match the winning lottery numbers and a prize amount; and sending, from the gaming engine server to an operator mobile money server, the prize amount to be credited to a prize account associated with the mobile device.

In some embodiments, the method also comprises the step of executing a self exclusion process wherein the engagement cloud server receives a self exclusion message from the mobile device, and the engagement cloud server sends the MSISDN of the mobile device, Unique ID of the mobile device, and the response to the gaming engine server.

In some embodiments, the method also comprises the step of providing a second chance cancel survey by executing the following steps: receiving the MSISDN of the mobile device and screen content from the gaming engine server at the engagement cloud server; sending a cancel survey from the engagement cloud server to the mobile device; receiving a user's survey response from the mobile device at the engagement cloud server; and sending the MSISDN of the mobile device and the user's survey response from the engagement cloud server to the gaming engine server.

In some embodiments, the method further comprises an opt-out process by executing the following steps: receiving the MSISDN of the mobile device and screen content from the gaming engine server at the engagement cloud server; sending screen content from the engagement cloud server to the mobile device; receiving an opt-out response at the engagement cloud server, wherein the opt-out response indicates that the mobile device should not be contacted about lottery gameplay; and transmitting the MSISDN and the opt-out response from the engagement cloud server to the gaming engine server.

In some embodiments, the method also comprises a billing process by executing the following steps: receiving the MSISDN of the mobile device, unique ID, and charge code from the gaming engine server at the operator billing server; transmitting the MSISDN of the mobile device and billing status to the gaming engine server from the operator billing server; sending a SMS message confirming purchase from the operator billing server to the mobile device; and communicating the billing event from the operator billing server to the gaming engine server.

In some embodiments, the method also comprises an intelligent billing process in the event of lack of sufficient funds by executing the following steps: receiving MSISDN of the mobile device, unique ID, and charge code from the gaming engine server at the operator billing server; communicating the MSISDN of the mobile device and the billing status from the operator billing server to the gaming engine server; transmitting a SMS regarding insufficient funds from the operator billing server to the mobile device; receiving a funds response from the mobile device at the operator billing server, wherein the funds response comprises a selection of an alternative game choice or an cancel option indicating that the process should be terminated; and sending the funds response and billing event from the operator billing server to the gaming engine server.

In some embodiments, the method also comprises a lottery number generation and player notification process and comprises the following steps: sending a billing event from the operator billing server to the gaming engine server; transmitting the MSISDN of the mobile device, lotto numbers options generated, or Get Input Box generated from the gaming engine server to the mobile device; sending instructions for presenting a display screen with Get Input Box or Lotto Number options by communicating information from the engagement cloud server to the mobile device; receiving a selection of number options generated or values of inputted numbers at the gaming engine server from the mobile device; sending assigned lotto numbers from the gaming engine server to the engagement cloud server; and, transmitting a SMS message with the assigned lotto numbers from the engagement cloud server to the mobile device.

The step of receiving a selection of number options generated or values of inputted numbers at the gaming server from the mobile device may comprise receiving a selection of numbers options generated or values of inputted numbers from the engagement cloud server. A payout process may also be included, wherein the payout process comprises the following steps: sending a SMS message confirming a win, MSISDN of the mobile device, and a SMS content from the gaming engine server to the engagement cloud server; communicating a SMS message confirming win from the engagement cloud server to the mobile device; granting access to the operator mobile money server to the mobile device; and sending a request for a prize amount from the operator mobile money server to the gaming engine server.

The method may present mobile money account screens with an existing account or without an existing account to the mobile device. Furthermore, all steps of the method may be activated by executing instructions stored on a SIM application on a User SIM card.

The disclosure further provides a gaming system for providing a lottery to a mobile device, the gaming system comprising: a gaming engine server; an engagement cloud server, wherein the engagement cloud server is communicatively coupled to the gaming engine server to receive game content; an operator billing server, wherein the operator billing server is communicatively coupled to the engagement cloud server; and an operator mobile money server, wherein the operator mobile money server is communicatively coupled to the mobile device. The engagement cloud server is configured to convert screen content into a format that may be displayed on the mobile device. The operator billing server is configured accept payments from a mobile device for mobile gaming subscriptions, and check accounts for mobile device users to permit ad hoc or automated withdrawals. The operator mobile money server is configured to store prizes that are won by the user of the mobile device.

Thus, the present disclosure provides a system or apparatus that enables the play of lottery-type games in a wider variety of contexts. The system differs from existing app-based lottery interfaces in that they rely on a conventional online payments-handling process which operates via the banking system and which excludes some potential players. According to embodiments disclosed herein, the system obtains funds for lottery gameplay via the same payment mechanism as that which funds the use of the mobile telephone handset—regardless of the nature of that payment mechanism, be it one employing the banking system or one maintained via vouchers purchased in person or online, via a digital wallet, or otherwise. Thus, the system employs an operator billing server which accesses the same mobile subscriber account as that from which funds are taken to pay for calls made, messages sent, or data used via the MSISDN in question. This applies despite the fact that the lottery game is unrelated to the operation of the mobile telephone handset. The fact that the handset is in operation is a prima facie indication that there is a reliable payment mechanism and therefore the system is in principle able to extend the availability of such games to any mobile handset owner. In some instances, the system confirms sufficiency of funds as part of the process for enabling gameplay. Furthermore, the system allows for other advantages which are set out herein, such as the ability to screen out subscribers whose account is not in good standing, to discourage potentially problematic gambling, and to disallow subscribers in an unintended geographic area who may be ineligible for a lottery game or for whom the cost of participation may be elevated due to roaming charges. The system allows mobile operators the ability to offer lottery games to their subscribers using the mobile operator's network.

### BRIEF DESCRIPTION OF THE FIGURES

These and other features and advantages of the invention will be better understood by reading the following detailed description, taken together with the drawings wherein like numerals correspond to like elements or steps throughout the several views.

FIG. 1 is block diagram of the gaming system in accordance with an embodiment of the invention.

FIG. 2 is signaling diagram of a method executed by the gaming system in accordance with an embodiment of the invention.

FIG. 3 is a user interface diagram that illustrates Recruitment Screens 1, 2, and 3.

FIG. 4 is a signaling diagram that illustrates the self exclusion process.

FIG. 5 is an illustration of an exemplary self exclusion text message.

FIG. 6 is a signaling diagram that illustrates the game play process according to an embodiment of the invention.

FIG. 7 illustrates the user interface screens for Game Play Screens 1, 2, and 3.

FIG. 8 is a signaling diagram that illustrates the second chance cancel survey process according to an embodiment of the invention.

FIG. 9 is a diagram that illustrates Game Play Screen 2.

FIG. 10 is a signaling diagram that illustrates the opt-out process according to an embodiment of the invention.

FIG. 11 is a diagram that illustrates the opt-out screens according to an embodiment of the invention, specifically, Game Play Screens 1, 2, and 3.

FIG. 12 is a signaling diagram that illustrates the billing process according to an embodiment of the invention.

FIG. 13 is a diagram that illustrates a billing screen according to an embodiment of the invention.

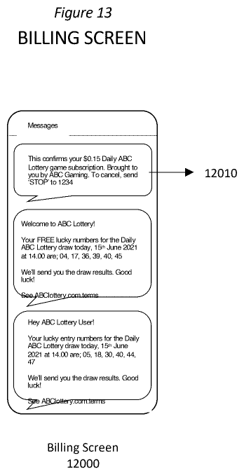

FIG. 14 is a signaling diagram that illustrates the intelligent billing process in the event of lack of sufficient funds according to an embodiment of the invention.

FIG. 15 is a signaling diagram that illustrates the intelligent billing process in the event of lack of sufficient funds according to an embodiment of the invention.

FIG. 16 is a signaling diagram that illustrates the lottery number generation and user notification process according to an embodiment of the invention.

FIG. 17 is a diagram that illustrates lotto number generation screens and a notification screen according to an embodiment of the invention.

FIG. 18 is a signaling diagram that illustrates the payouts process according to an embodiment of the invention.

FIG. 19 is a diagram that illustrates the payouts screen in accordance with an embodiment of the invention.

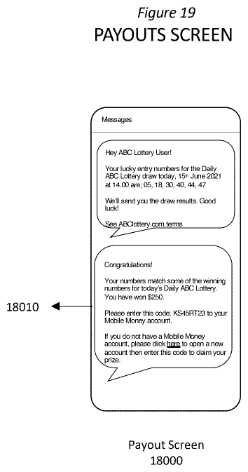

FIG. 20 is a diagram that illustrates MNO mobile money account screens (with an existing account) according to an embodiment of the invention.

FIG. 21 is a diagram that illustrates the MNO mobile money account screens (with no existing account) according to an embodiment of the invention.

### DETAILED DESCRIPTION

While the term SIM is often used to generically describe any type of subscriber identity management within the mobile industry, this disclosure is inclusive of all SIM technologies including but not limited to USIM, eSIM, iSIM, and SIM—as the methods disclosed herein could be deployed in any of these technology environments.

While many types of game play could be envisioned using the methods outlined, the focus and primary use case described within this disclosure involves lottery game play including games of chance, betting games, and games with fixed based odds. This disclosure provides methods and systems for playing lottery and jackpot games over mobile networks. Although the terms “lottery” and “jackpot” can refer to different types of games of chance, this disclosure is directed to both and encompasses both. Unless indicated otherwise by context, the use of the term “lottery” includes “jackpot” games. Furthermore, although this disclosure frequently references lottery “numbers,” lotteries can be played using numbers, letters, images, emojis, other variables, randomized sets of data, and combinations thereof. As used herein, unless indicated otherwise by context, reference to lottery “numbers” includes lotteries using numbers, letters, images, emojis, other variables, randomized sets of data, and combinations thereof.

This disclosure provides a new mobile system that promotes and enables lottery game play for mobile network subscribers via a top screen mobile interface powered by a mobile application embedded within a SIM card used in the subscriber's mobile device. Alternatively, in some embodiments, this mobile application is embedded within the mobile operating system of the device, or available as an over-the-top application that a mobile user could download from a mobile application store, such as the GOOGLE PLAY™ store.

In some embodiments, the gaming SIM application allows mobile customers to choose and pay for their preferred games using their mobile account balance. In some embodiments, their mobile account balance comprises a balance of minutes, data, money, or a combination thereof. In some embodiments, a mobile device user can use their mobile account balance to pay to play a lottery game. The systems and methods disclosed herein allow Mobile Operators to enable mobile device users to play a lottery using their account balance or by another linked payment method. The systems and methods of this disclosure facilitate lottery play with lottery games around the world.

In some embodiments, the mobile lottery service functions according to the following scenario:

In one embodiment, the lottery service sends a digital screen message to users prompting them to opt-in to future lottery gaming. Choosing to opt-in to the service will result in users receiving future messages with different lottery choices for the chance to win prizes. Users can play on a one-time, ad-hoc, or subscription basis.

Users have the ability to select which lottery games they would like to play. In some embodiments, there may be a variety of lottery games from which to select with different prize amounts associated with each and communicated accordingly to the user.

When a particular lottery game is chosen, users may have the option to select from different price bundles, where a larger bundle enables more chances to play.

Once all game play selections are made, a confirmation is sent to the user via SMS (Short Message Service).

Lottery number draws are then conducted. In some embodiments, the lottery numbers from a known established lottery, including state-run lotteries, are used as the winning numbers or other winning variable (e.g., letters, images, emojis, etc.). In some embodiments, the system generates the winning numbers. In embodiments where the system generates winning numbers, the system can use a certified Random Number Generator (“RNG”). In some embodiments, the winning numbers or other variables are randomized and chosen at a set time. In still other embodiments, the system acts as the lottery provider or partners with a lottery provider. The winning numbers that were drawn are communicated to all users via an SMS.

If a user has won, the Gaming Engine sends a congratulations message to the user with instructions for claiming their prize.

Lottery games may be linked to national or global lottery draws. In other embodiments, lottery games may be based on games of chance where a user providers a specific unique identifier—such as a National ID—that may serve as the winning combination of numbers. In some embodiments, the system randomly selects a specific unique identifier as the winner.

### SUMMARY OF SYSTEM ARCHITECTURE

The Gaming System comprises the Gaming Engine Server, the Engagement Cloud Server, the Operator Billing Server, the Operator Mobile Money Server, and, in some embodiments, a Mobile Device.

The Gaming Engine Server produces the lottery game services and provides game contents to the Engagement Cloud Server. In some embodiments, the Gaming Engine Server runs the lottery elements including lottery number generation, drawing winning lottery numbers, and providing prize money to users. In some embodiments, the Gaming Engine Server retrieves winning lottery numbers from an established lottery and uses those numbers as the winning numbers for the users playing a lottery on the Gaming System.

In some embodiments, the Engagement Cloud Server connects all components of the Gaming System. In some embodiments, whenever content or information is exchanged between systems, the Engagement Cloud Server acts as the gateway for ease and accessibility. In other embodiments, the Gaming Engine Server, the Engagement Cloud Server, the Operator Billing Server, the Operator Mobile Money Server are operably connected and communicate directly with each other.

The Operator Billing Server is the system that enables the user to pay for their mobile gaming subscriptions. Operator Billing Server checks user accounts and allows ad hoc or automated withdrawals from a user account to pay to play the lottery games. In some Mobile Operators, this may also be referred to as an Airtime Server, or a Subscription Management Platform.

The Operator Mobile Money Server acts as the receiver for any prizes that the user wins. In some embodiments, the Operator Mobile Money Server is used when the user wins money. In some embodiments, the Operator Mobile Money Server deducts the amount from a Gaming Engine Account associated with the Gaming Engine Server. The Operator Mobile Money Server can send the prize amount to the winning account.

The User Mobile Device is the device with which a user interacts with the Gaming System. The User Mobile Device displays content provided from the other components of the Gaming System and allow the user to play the lottery game. The User Mobile Device includes a SIM Card (“User SIM Card”). In some embodiments, a mobile lottery SIM Application (also referred to herein as the “SIM Application”) is pre-loaded to the User SIM Card. The SIM Application communicates with the Engagement Cloud Server and creates the user interface on a screen of the User Mobile Device. Similarly, the SIM Application collects the user's responses from the User Mobile Device screen and transmits the user responses to the Engagement Cloud Server.

### SUMMARY OF SYSTEM PROCESS

Mobile Operators can offer this service to the Mobile Operator's customers. Mobile Operators can provide this service on their own or through an affiliate or a third party. When offering the service, Mobile Operators can inform and recruit users of their mobile network. The recruitment process starts with the Engagement Cloud Server sending a message to a plurality of subscribers. Mobile Operators can target all subscribers or a certain subset of subscribers. To target subscribers with a recruitment message, a Mobile Operator can create a campaign to recruit subscribers to play. Mobile Operators can create a campaign to target certain subscribers based on certain criteria. For example, criteria can include the length of time a subscriber has had an account with the Mobile Operator, accounts having over a minimum amount of credit balance, whether an account is in good standing, for how long an account has been in good standing, area code, billing zip code, and geographic area. A campaign can be configured to run for a set duration of time and can be configured to send a predefined number of recruitment messages. For example, if a lottery service is being offered based on an established or state-run lottery draw, the Mobile Operator can configure the campaign to send recruitment messages to subscribers as the draw time nears, e.g., one, two, or three hours before the draw time or the day of the draw. The timing of the recruitment message can vary depending on whether the established or state-run lottery, or mobile operator-run lottery, has a weekly, bi-weekly, or daily draw.

In some embodiments, the recruitment message is sent to a SIM Application which resides within a SIM card. The mobile lottery SIM Application receives the message and displays a prompt on the user's device with a message inviting the mobile device user to play a lottery game.

In one example, the recruitment message states “Win $250,000 Every Day! Play Daily Lottery & get one FREE chance to WIN the daily jackpot. You must be 18+ to play. Click to play . . . ” The user selects “Accept” (or equivalent on his mobile device) and a second screen is displayed which, in some embodiments, reads “Choose the number of games you want to play each day: 1×Game: $0.15, 3×Game: $0.50, 5×Game: $0.75, 10×Game: $1.25”.

In some embodiments, to ensure that the user understands what he is agreeing to purchase, a double opt-in confirmation may be used. In some embodiments, after the user clicks their game choices and accepts, the mobile lottery SIM Application interface displays a message asking the user to confirm their purchase. In one example, such a message could read:

“Confirm ABC Lottery daily subscription @ $0.15 per for your chance to win $250,000 EVERY single day! Don't forget, you get 2 games for the price of 1! Ts & Cs at ABClottery.com.terms” In this example, “Ts & Cs” refer to the terms and conditions established by the Mobile Operator. The mobile lottery SIM Application collects the user's “accept” response and sends this information to the Engagement Cloud Server. The Engagement Cloud Server collects the MSISDN (Mobile Station International Subscriber Director Number) and user response from the message. In some embodiments, the Engagement Cloud Server assigns a Unique ID associated with the MSISDN. In some embodiments, the Engagement Cloud Server uses the mobile device's MSISDN as the Unique ID for use in the Gaming System. The Engagement Cloud Server sends the MSISDN, Unique ID (if used), and user response to the Gaming Engine. The Gaming Engine stores the MSISDN/Unique ID and user's choice within the Gaming Engine Server. In some embodiments, the Engagement Cloud Server also stores this information. In some embodiments, the information collected by the SIM Application and stored at the Gaming Engine or the Engagement Cloud Server, or both, also includes the device type of the mobile device, preferred format of the mobile device, and/or the preferred communication channel associated with the mobile device.

If the user chooses “Opt-out” within the mobile lottery SIM Application interface, then the opt-out choice is sent to the Gaming Engine Server. The user's MSISDN, response, and Unique ID (if used) are stored within a memory in the Gaming Engine Server. The Gaming System will not contact this MSISDN/user/Unique ID about this game in the future or for a defined amount of time. Users can opt-out of the service at any time. In some embodiments, the user can opt out for a certain amount of time.

In some instances, a user may be outside of his home country and may want to avoid unexpected roaming charges. In this case, the system can be configured such that the mobile lottery SIM Application automatically recognizes that the user is out of the country and does not display any prompts. The user may also set whether he would like to receive notifications and prompts while roaming.

### Self-Exclusion Process

Mobile users who suffer from a gambling addiction or a known issue with gaming and gambling may wish to exclude themselves from receiving any lottery content through this service. The Self Exclusion feature allows a mobile subscriber to easily turn off game play and all notifications relating to the mobile lottery service. The user has the ability to place themselves on a lottery self-exclusion list. When placed on this list, the Gaming System will not target the user with any prompts or notifications about the lottery. This process can be completed through a variety of actions. The mobile user may place themselves on the Self Exclusion list via the Gaming Engine Website Interface or by sending an SMS message with a keyword to a designated short code or designated number which triggers the automated logic within the Gaming Engine Server.

When the user is directly placing themselves on the Exclusion list through the Gaming Engine Website Interface, they may the option to choose “temporary exclusion,” where the user may not be targeted for a specified time period, e.g., six months later, or “permanent exclusion,” where the user will not be targeted until they remove themselves from the exclusion list. If the user used the SMS message feature to place themselves on a Self-Exclusion list, the user may set the exclusion timing by typing the time within their keyword. For example, if the user would like to place themselves on the Self Exclusion list for 30 days, they would send a STOP30 keyword via SMS.

### Game Play

The Gaming Engine Server provides the Engagement Cloud Server with game content to be displayed on a mobile device. The Engagement Cloud Server converts the screen content into a format that can be displayed on the user's mobile device. The content may be sent to a standard SMS inbox or may be sent via formatted messages such that the mobile lottery SIM application will display the messages to the user. In some embodiments, the Gaming Engine Server and/or the Engagement Cloud server store the format of the message sent to the mobile device.

The mobile lottery SIM Application displays the game play screens via an interface and enables the collection of the user's response. In one example, a first-time game play screen could appear as:

“Win $250,000 Every Day! Play ABC Daily Lottery & get one FREE chance to WIN the daily jackpot. You must be 18+ to play. Click to play . . . ” If the user clicks “Cancel,” the SIM Application sends the user selection back to the Engagement Cloud Server. The Engagement Cloud Server then sends this information to the Gaming Engine Server.

When the user clicks “Accept,” (or a similar confirmation response) the Gaming Engine can be configured to allow the user to then select from a menu of different bundle options. In some embodiments, the next screen could appear with contents such as:

“Choose the number of games you want to play each day:
1×Game: $0.15
3×Game: $0.50
5×Game: $0.75
10×game: $1.25”

In some configurations, after making a selection the user is asked to confirm the purchase. For example, a confirmation prompt could read: “Confirm Daily ABC Lottery subscription @ $0.15 per day for your chance to win $250,000 EVERY single day! Don't forget, you get 2 games for the price of 1! Ts & Cs at ABClottery.com.terms.” Once the user clicks “Accept,” the Engagement Cloud Server will collect the information (e.g., how many games they would like to play per day, cost, etc.) from the mobile lottery SIM application and send it to the Gaming Engine.

As a myriad of game types are available, the system has the intelligence to recognize the specific game preferences of a user over time and will automatically serve those suggestions to the user as the prominent game play options. The system can recognize and make suggestions by storing the game choices and preferences of a user associated with an MSISDN. As time goes on, the system can offer game play options to a user based on previous options selected and stored in association with the MSISDN. In some embodiments, users may have the choice to subscribe to a daily, weekly, or monthly game type where the user is automatically entered into the game or drawing and charged accordingly, provided the user has sufficient balance or payment available.

Similarly, the system may be configured with a Contact Policy to limit the number of times a user sees offers for a specific game or is able to purchase a specific game. The Contact Policy may also be intelligently configured to show fewer gaming suggestions to the user if the user has repeatedly cancelled the gaming prompts. In some embodiments, the system creates the Contact Policy, in part, by storing the user's responses. Users may also set their own Contact Policies by silencing the notifications for a specific period of time (for example, no notifications or prompts for 30 days).

### Second Chance Cancel Survey

If at any point, the user clicks “Cancel” on any of the game play screens, the mobile lottery SIM Application will send the user's selection back to the Engagement Cloud Server. The Engagement Cloud Server will then send this information to the Gaming Engine Server to be stored.

The mobile lottery service can be configured to collect additional intelligence about user preferences when a user decides to cancel the gaming journey. In one example, the service could be configured to display a screen that reads:
“Please select why you Cancelled today's lotto:
Remind me later,
Play a different game,
Opt-out of lottery”.

Once the user selects an option, the response is sent from the mobile lottery SIM Application to the Engagement Cloud Server and is then subsequently sent to the Gaming Engine Server. If the user selects “Remind me later”, the Engagement Cloud Server can collect this information and send it to the Gaming Engine Server. The user will be contacted again for the same game at a pre-configured time. If the user selects “Play a different game”, then the user is presented with a screen with a selection of lottery games from which the user can choose. The system has the intelligence to store the user's preferences and, in the future, the user will be presented with their preferred lottery selections. The system can store the preferences associated with an MSISDN or Unique ID. “Opt-out of lottery” follows a process similar to the opt-out user journey outlined in the before mentioned Recruitment process. In some embodiments, the Gaming Engine and/or the Engagement Cloud Server stores the user's preferences.

The Second Chance Cancel Survey is fully configurable and may be shown every time the user cancels a game play screen. In other embodiments, the Cancel Survey may only be displayed the first time the user selects “Cancel” within a specific game play user journey. The Cancel Survey could be shown only for specific lottery games, and not for others. Alternatively, the Gaming Engine can be configured to only display a Cancel Survey a predetermined number of times for a specific user either across all games the user chooses, or only across a specific set of games played. The Gaming Engine also has the intelligence to delay the Second Chance Cancel Survey screens such that they are “quieted,” or not displayed for a specific period of time (for example: 14 days).

### Opt-Out

The system also has the intelligence to only continually target mobile users who have expressed interest in receiving game play promotions and notifications. If the user clicks “Cancel” on any prompt a specified number of times in a row, the system can be configured to automatically ask the user if they would like to stop notifications or promotions for a specific game type, or for all games and lottery. For example, if a user clicks cancel two or more times, or a certain number of times in a row, the system can send a message confirming that the user is not interested. The number of times a user selects “cancel” or “ignore” before an op-out message is triggered can be once, two times, or any number. For example, in this case, the mobile lottery SIM application can display a screen that reads “It looks as if you aren't interested in receiving these gaming notifications. Would you like to take a break or opt-out from further notifications?” If the user clicks “OK”, the Gaming Engine determines the next best action for the user based on preconfigured user journeys within the system. In some embodiments, the next action can be an option to opt out forever, an option to opt out for a certain number of days or time period, or an option to opt out of a specific game type. The Gaming Engine sends the notification to the Engagement Server, which formats the message such that the mobile lottery SIM application can display the next set of screens to the user. In one example, the next screen with the Opt-out options could read:
“Please make a selection:
Opt-out for 30 days
Opt-out from this game
Opt-out of all games”

The Engagement Cloud Server collects the user's chosen response, sent from the mobile lottery SIM application, and forwards it to the Gaming Engine Server to be stored. If the user clicks “Opt-out for 30 days,” the user will not be notified about any games or promotions for 30 days. “Opt-out from this game” will remove notifications for the specific game the user is currently playing, while “Opt-out of all games” stops all notifications about the lottery service.

### Billing, User Payment

Once the game play selections are received from the user, the Gaming Engine Server sends the MSISDN and associated Game Charge Code to the Operator Billing Server. In some embodiments, the Operator Billing Server notifies the Gaming Engine that it has received the user's order. In some embodiments, the Gaming Engine Server holds the order placement until it receives the payment confirmation from the Operator Billing Server. In some embodiments, the Operator Billing Server sends an SMS message to the mobile device and informs the user about their purchase. The Gaming Engine can also be configured to send a confirmation to the user (in some embodiments, sent via the Engagement Cloud Server and, in some embodiments, displayed to the user via the mobile lottery SIM application). In one example, the billing confirmation message could read “This confirms your $0.15 Daily Lottery daily game subscription. Brought to you by ABC Gaming. To cancel, send ‘STOP’ to 1234.” Operator Billing Server identifies the mobile account associated with the MSISDN and deducts the game play cost from the account. Then, the Operator Billing Server sends confirmation of the billing event to the Gaming Engine Server so the Gaming Engine Server has confirmation of payment prior to sending lottery numbers or a lotter “ticket” to a user. In some embodiments, a successful billing event occurs prior to sending lottery numbers or a lottery ticket to a user. In some embodiments, information passed to the Gaming Engine can include parameters such as: Billing Amount, Date, Time, Transaction ID, Game Charge Code.

In some embodiments, the system can be configured so a user may unsubscribe from game play at any time, which ceases any automated payments. Users may pay for the gaming options and/or tickets using a credit card, a mobile operator's mobile wallet application, a mobile money application or via mobile airtime, via mobile account credit, via prepaid mobile account, or via a digital wallet. In some embodiments, a user can use a digital wallet set up with the lottery service. The user can fund the digital wallet with a credit card or by linking to a bank account. In some embodiments, any winning amounts are credited to the user's digital wallet and the user can use those amounts to play future games. In some embodiments, the user can use a mobile wallet set up independently of the mobile operator or lottery service. Providing users with a multitude of payment options increases game play—specifically in regions where mobile users may not have credit cards or may be unbanked.

### Intelligent Billing, Lack of Sufficient Funds

If a user selects a game but does not have sufficient funds to play the game, the Gaming Engine has the intelligence to check the account balance and to suggest a game option that can be purchased given the available balance. The Operator Billing Server would report to the Gaming Engine Server that the user does not have sufficient funds. The Gaming Engine Server would then hold the order placement while the Operator Billing Server sends a message to the user to inform them that they do not have sufficient funds to play that specific game. This message might read “You currently have insufficient funds to play this game. Reply with ”CANCEL“ to cancel the game. You may play the Lucky Draw game with the funds in your account. If you would like to play this game reply with PLAY.” The mobile lottery service intelligent billing feature provides the user the option to choose from a variety of other games that are within the user's funds allotment.

In other embodiments, the Gaming Engine may automatically attempt to purchase the lowest price option in the scenario where a user has insufficient funds for the initial selection (for example, one ticket is automatically purchased instead of a bundle of tickets for the same game). The user is then informed than an alternative purchase was made.

The Gaming Engine can also be configured to query the Operator Billing System in the event that a user has insufficient funds. In this scenario, if an insufficient funds response is returned from the Operator Billing System, the Gaming Engine can query the Operator Billing System to determine how much balance the user has. Based on the response, the Gaming Engine can intelligently suggest a new set of gaming options to the user, based on the available balance.

In some embodiments, the Operator Billing Server can check the account history associated with an account to determine whether the account has had any late payments or any delinquency notices. If there are no late payments or delinquency notices, the Operator Billing Server can approve an extension of credit to the account to play the lottery game. In some embodiments, the Operator Billing Server can communicate with a credit rating agency regarding the account owner's credit or otherwise assess the credit worthiness of an account and approve an extension of credit to the account to play the lottery game.

### Lottery Number Generation and User Notification

Once the user has paid, the user selects numbers, letters, images, emojis, or a combination thereof as the user's lottery selection. This disclosure frequently refers to selection or generation of lottery “numbers.” However, a lottery can be based on numbers, letters, images, emojis, and combinations thereof. Reference in this disclosure to lottery “numbers” encompasses numbers, letters, images, emojis, and combinations thereof. Number selection may be completed using several different methods. These methods could include:
Auto generation, where numbers are generated by the gaming system, for example by a Random Number Generator (RNG) also known as a randomizer;
User definition, where individual numbers are manually chosen by the user;
or user selection from a menu, where the user chooses from a selection of auto generated number sets from a menu.

The Gaming Engine can be configured to offer the user a choice in how numbers are selected, or alternatively, may be configured to only allow number selection in a specific manner (for example, all numbers are auto generated by the system). This disclosure describes many different games and game play can vary. The disclosure provides descriptions of various lottery games. However, the types of lottery games described herein are not meant to be limiting. This disclosure is directed to all types of lottery games that can be played over a mobile network using the methods and systems described herein. In some embodiments, the user also chooses or is given, a bonus number.

In some embodiments of a lottery game, a user selects between 5-9 unique numbers from a pool of available numbers. The pool of available numbers can range from 20 to over 100. In some embodiments, a user selects 6 numbers from a pool of about 44 to about 65 available numbers, and one bonus number. In some embodiments, a user is given, or chooses to receive, “quick-pick” numbers that are autogenerated.

In other embodiments, a lottery game can be linked to a holiday. In some embodiments, for example a lottery game such as “20 days of Christmas,” a user has a number of days, e.g., between 2 and 30, days to purchase draw tickets with a chance to win a large prize with the winning numbers drawn on Christmas Eve. In some embodiments, the user receives quick pick numbers from a pool of available numbers. In other embodiments, the user selects the numbers from a pool of available numbers. In some embodiments, the use also selects a bonus number. In some embodiments, the user's numbers must all match the winning numbers in order to win the grand prize.

Other games will utilize a similar random, unique draw concept, i.e., where only one number or letter or picture is chosen from a set and the user must match all the letters or numbers or pictures to win. In some games, it may be a letter and number combination. In other games, it may be a set of pictures. In still other embodiments, the game could be a combination of letters, numbers, and pictures. In some embodiments, the winning draw comprises a string of emojis and, to win, a player must match the string of emojis. In some embodiments, a user selects, or receives an autogenerated selection (chosen by a random number generator (RNG), also known as a randomizer), of emojis from a set of 45 or more.

Other lottery games included herein include a raffle draw. In this embodiment, a user is assigned a unique number from a digital raffle “book.” For example, a raffle book number may be 101. Users would then purchase tickets in sequential order from a starting number (e.g., 01) to an ending number in book number 101. There would be a set number of tickets per book and a set number of books. In such embodiments, when all of the tickets in a book are sold, the game closes and a winning ticket is drawn. In these embodiments, one user wins because all of the tickets have been sold.

If the user has chosen to have game play numbers automatically generated, the Gaming Engine Server will randomly generate a set of playable numbers (Example: 04, 17, 36, 40, 45) for this user.

If the user chooses to select their own numbers individually for game play, they will be prompted by the mobile lottery SIM application to enter their chosen numbers into a prompt within the mobile application screen. The SIM application may use a “Get Input” command in order to display and collect this information. The Gaming Engine Server validates the numbers to ensure that appropriate number selections were entered. If the numbers are not valid, the user is notified and the user has another chance to correctly enter a set of chosen numbers for game play. In other scenarios, game play numbers may be collected via SMS or USSD.

In the scenario where the user chooses numbers for game play from a menu, the system can send the user multiple sets of numbers and displays these to the user via the mobile lottery SIM Application interface in a menu format. The user can review each of the sets, and select the number set they would like to use for play. The user is able to review the number set and determine if they would like to keep the numbers or have the system generate a new set of numbers for game play.

Once the user selects numbers for game play using any of the beforementioned methods, the Engagement Cloud Server collects the user's response and sends it to the Gaming Engine Server. The Gaming Engine Server stores these randomly generated lotto numbers (in this example: 04, 17, 36, 40, 45) in user's account. The Gaming Engine Server provides the Engagement Cloud Server with the user's MSISDN and assigned lotto numbers. The Engagement Cloud Server prepares a message to the user, which may be sent as a regular SMS or may be sent such that it is displayed via the mobile lottery SIM application interface. The message includes the chosen lottery numbers for the user.

The Gaming Engine can be configured to display a set of confirmation messages to the user. For example, the Gaming Engine can have the intelligence to recognize that it is the first lottery game being played by the unique user. In this example, the system could be configured to allow award a free ticket for the first time user. The confirmation messages may read: “Welcome to ABC Lottery! Your FREE lucky numbers for the Daily ABC Lottery draw today, 15 Jun. 2021 at 14.00 are; 04, 17, 36, 40, 45. We'll send you the draw results. Good luck! See ABClottery. com/terms.” The second confirmation message could disclose the numbers for the game that the user purchased. This message could read “Hey ABC Lottery User! Your lucky entry numbers for the Daily ABC Lottery draw today, 15 Jun. 2021 at 14.00 are; 05, 18, 30, 40, 44, 47.” In some embodiments, the message has an option to cancel participation in the game up until a certain time before the winning lottery numbers are drawn. In some embodiments, the message has an option to cancel if the numbers shown in the message were not the user's desired numbers.

### Winning Payout

If a user wins a lottery game, the Gaming Engine Server will provide the Engagement Cloud Server with the winning content messages to display to the user. In some embodiments, the winning content comprises the prize amount and how the prize amount will be sent to the winner. The Engagement Cloud Server can convert the content into proper formatting and can send an SMS message to the user. The message displayed to the winning user is fully configurable and can be changed within the Gaming Engine at any time. As an example, the notification message sent to the winning user could read:

“Congratulations! Your numbers matched the winning numbers for today's Daily Draw. You have won $250. Please enter this code: KS45RT23 in your Mobile Money account to claim your prize. If you do not have a Mobile Money account, please click here to open a new account then enter this code to claim your prize. www.MNOmobilemoney.com.”

In some embodiments, the system will credit the mobile money account associated with the MSISDN. If the user has an existing Mobile Money account, the user will log into the account and enter the keyword into their account to claim their prize. If the user does not have an existing Mobile Money account, they can create a new account and then enter the keyword into their account to claim their prize. Once the keyword is entered, the Mobile Operator Mobile Money Server will deduct the winning amount from the Gaming Mobile Money account and credit the amount to the user's Mobile Money account.

### System Architecture

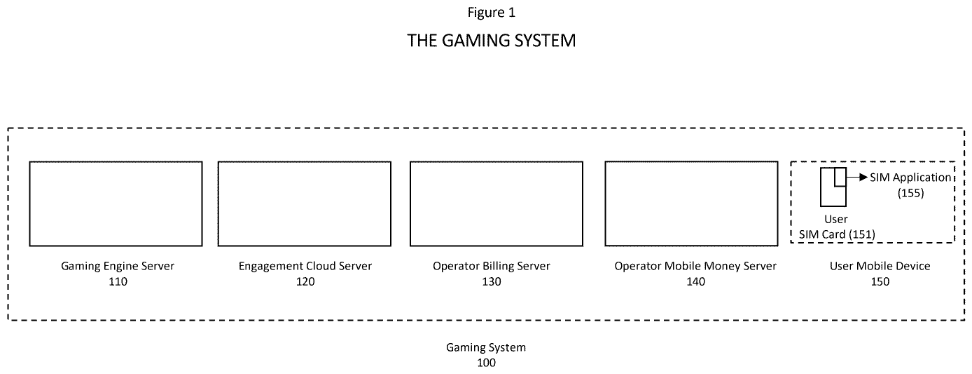

An embodiment of the system architecture is illustrated in FIG. 1.

Gaming System (100) in FIG. 1 is comprised of the Gaming Engine Server 110, the Engagement Cloud Server 120, the Operator Billing Server 130, the Operator Mobile Money Server 140, and User Mobile Device 150. For readability, this disclosure sometimes omits the term “Server” from “Gaming Engine Server,” and, instead, refers to Gaming Engine 110. Gaming System (100) is operably connected to a Mobile Operator's network.

Gaming Engine Server (110) produces the lottery game services and provides game contents to Engagement Cloud Server (120) in FIG. 1. Gaming Engine Server (110) runs the lottery elements including lottery number generation, drawing winning lottery numbers or retrieving of lottery numbers from an outside established lottery, and providing prize money to user accounts.

In some embodiments, Engagement Cloud Server (120) in FIG. 1 connects all components of the Gaming System (100). In some embodiments, whenever content or information is exchanged between systems, Engagement Cloud Server (120) acts as the gateway for ease and accessibility. In some embodiments, Gaming Engine Server 110, Engagement Cloud Server 120, Operator Billing Server 130, Operator Mobile Money Server 140, and User Mobile Device 150 communicate directly with each other.

Operator Billing Server (130) in FIG. 1 is the system that enables the user to pay for their mobile gaming subscriptions. Operator Billing Server (130) checks the users'mobile accounts and allows ad hoc or automated withdrawals to pay for the games. For some Mobile Operators, this may also be referred to as an Airtime Server, or a Subscription Management Platform.

Operator Mobile Money Server (140) in FIG. 1 acts as the receiver for any prizes that the user may win. In some embodiments, Operator Mobile Money Server (140) is used when the user wins money and will deduct the amount from a lottery account maintained at the Gaming Engine. Operator Mobile Money Server (140) can create mobile winning accounts associated with users via their MSISDNs or Unique User IDs.

User Mobile Device (150) in FIG. 1 is the device with which a user interacts with the Gaming System. Mobile Device (150) displays content provided from the components of the Gaming System (100) and allow the user to play the lottery game. User Mobile Device (150) includes a SIM Card (“User SIM Card”) (151). In some embodiments, a Gaming SIM Application (155) is pre-loaded to the User SIM Card (151). In some embodiments, Gaming SIM Application (155), also referred to as “SIM Application (155),” communicates with Engagement Cloud Server (120) and creates the user interface on the User's Mobile Device screen. Similarly, the SIM Application collects the user's responses from the screen of User Mobile Device (150) and transmits the user responses to the Engagement Cloud Server (120).

### System Process

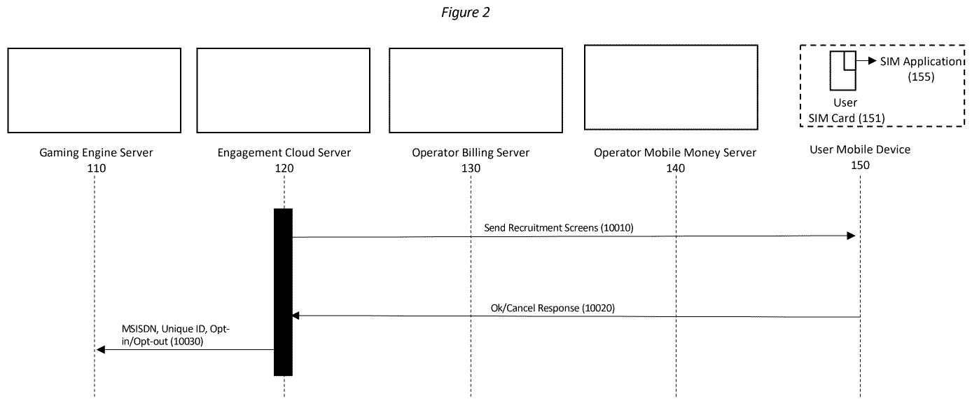

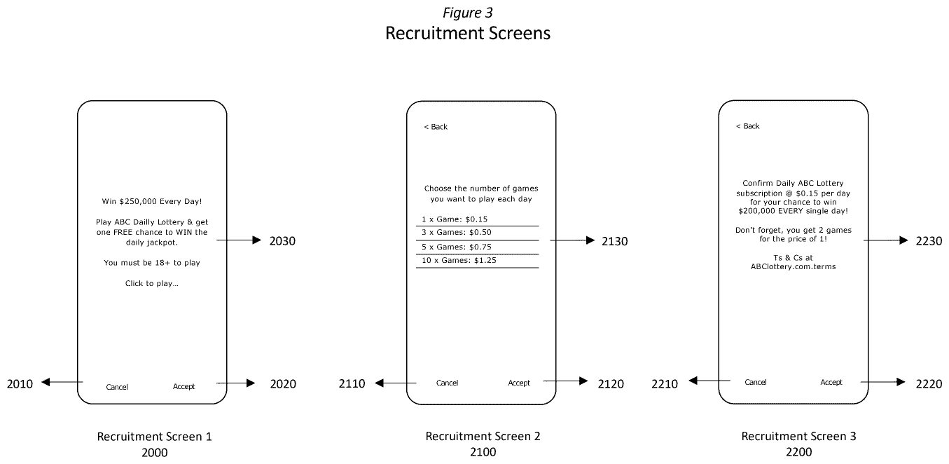

The Recruitment Process is illustrated in FIGS. 2-3.

The recruitment process starts with the Engagement Cloud Server (120) in FIG. 2 sending a message to potential users in Step 10010. Mobile Operators can create a campaign to send a recruitment message to all users or a subset of users based on criteria of the Mobile Operator's choosing. Mobile Operators can also set a duration of time that a recruitment campaign should run, how many messages to send to users, and days and times that messages should be sent. The message is sent to a potential user's SIM application (155) which resides within User SIM card (151). The mobile lottery SIM application (155) receives the message and displays a prompt on the user's device with a message in Step 10010.

Recruitment Screen 1 (2000), Recruitment Screen 2 (2100), and Recruitment Screen 3 (2200) illustrate screens used in the recruitment process. In one example, message 2030 states “Win $250,000 Every Day! Play ABC Daily Lottery & get one FREE chance to WIN the daily jackpot. You must be 18+ to play. Click to play . . . ” If the user selects “Accept” 2020 (or equivalent on his mobile device), a response is sent at step 10020 second message (2130) is displayed which, in some embodiments, can read as “Choose the number of games you want to play each day: 1×Game: $0.15, 3×Game: $0.50, 5×Game: $0.75, 10×Game: $1.25” in FIG. 3 and in Step 10010 in FIG. 2.

In some embodiments, after “Accept” 2120 is selected, and to ensure that the user understands what he is agreeing to purchase, double opt-in confirmation message 2230 can be displayed. After the user clicks their game choices and accepts, SIM Application (155) will cause an interface to display a message asking the user to confirm their purchase via “Accept” (2220) in FIG. 3. In one example, such a message could read:

“Confirm ABC Lottery daily subscription @ $0.15 per for your chance to win $250,000 EVERY single day! Don't forget, you get 2 games for the price of 1! Ts & Cs at ABClottery.com.terms” The mobile lottery SIM Application (155) collects the user's “accept” response and sends this information to Engagement Cloud Server (120). Engagement Cloud Server (120) collects the MSISDN (Mobile Station International Subscriber Director Number) and user response from the message. In some embodiments, Engagement Cloud Server (120) assigns a Unique ID associated with the MSISDN. In some embodiments, Engagement Cloud Server (120) uses the MSISDN at the identifier. Engagement Cloud Server (120) sends the MSISDN, unique ID (if used), and user response to Gaming Engine Server (110) in Step 10030. Gaming Engine Server (110) stores the Unique ID and user's choice. In some embodiments, Engagement Cloud Server (120) also stores the MSIDN, Unique ID (if used), and the user's choice.

If the user chooses Cancel 2010, 2110, or 2210, then the opt-out choice is sent to Gaming Engine Server (110). If the user chooses “Opt-out” within an interface of the mobile lottery SIM Application (155), then the opt-out choice is sent to Gaming Engine Server (110). The user's MSISDN, response, and Unique ID are stored within into Gaming Engine Server (110) at step 10030. This user will not be contacted about this game in the future. Users can opt-out of the service at any time.

In some instances, a user may be outside of his home country and may want to avoid unexpected roaming charges. In this case, the system can be configured such that the mobile lottery SIM Application (155) automatically recognizes that the user is out of the country and does not display any prompts. The user may also set whether he would like to receive notifications and prompts while roaming.

### Self-Exclusion Process

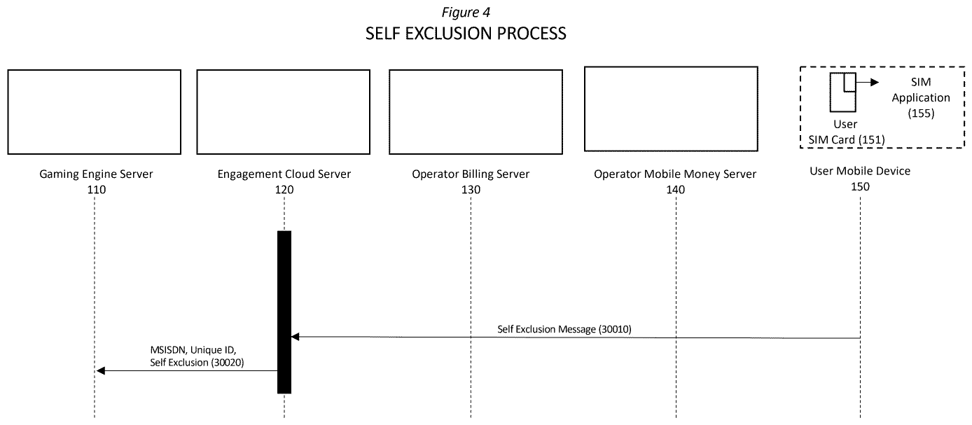

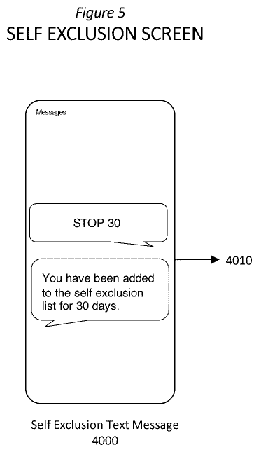

The Self Exclusion Process is illustrated in FIGS. 4-5. Mobile users who suffer from a gambling addiction or a known issue with gaming or gambling may wish to exclude themselves from receiving any lottery content through this service. The Self Exclusion feature allows a mobile subscriber to easily turn off game play and all notifications relating to the mobile lottery service. The user has the ability to place themselves on a lottery self-exclusion list. When placed on this list, the Gaming System (100) will not target the user with any prompts or notifications about the lottery for a period of time. This process can be completed through a variety of actions. The mobile user may place themselves on the Self Exclusion list by accessing a website associated with the Gaming Engine Server (110) or by sending an SMS message with a keyword to a designated short code or designated number which triggers the automated logic within the Gaming Engine Server (110) in Step 30010. Gaming Engine Server (110) collects the MSISDN and the user's choice and stores this information at step 30020.

When the user is directly placing themselves on the Exclusion list through a website associated with the Gaming Engine Server (110), they can have the option to choose “temporary exclusion,” where the user may be targeted (for example) six months later, or “permanent exclusion,” where they will never be targeted until they remove themselves from the list. If the user used the SMS message feature to place themselves on a Self-Exclusion list, the user may set the exclusion timing by typing the time within their keyword. For example, if the user would like to place themselves on the Self Exclusion list for 30 days, they would send a STOP 30 keyword via SMS as shown in screen (4010) in Self Exclusion Text Message 4000 in FIG. 5.

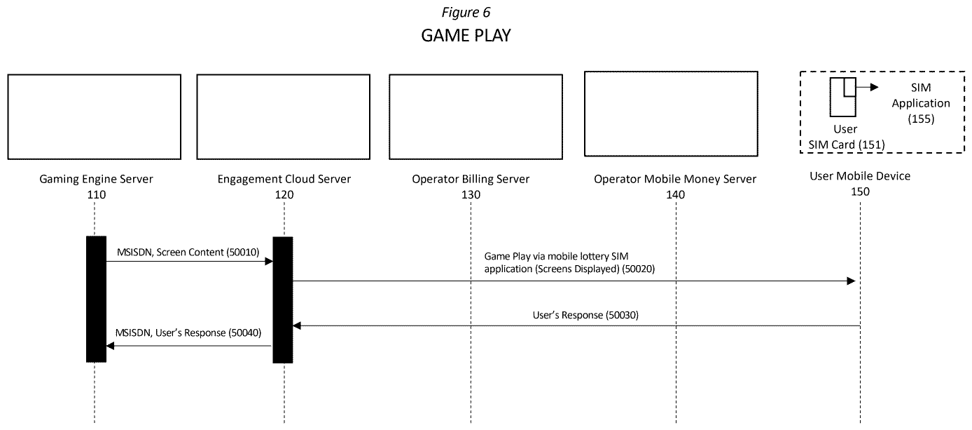

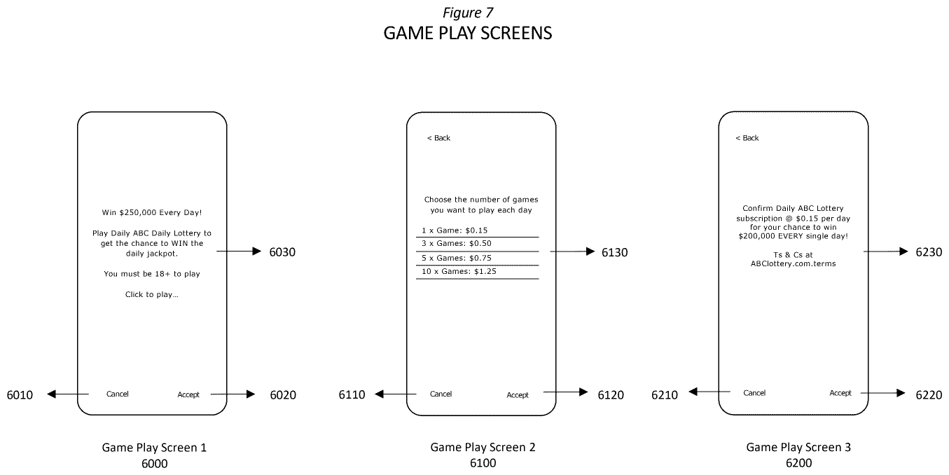

### Game Play As Illustrated in FIGS. 6-7

Gaming Engine Server (110) provides Engagement Cloud Server (120) with the game content that should be displayed to the user in Step 50010. In some embodiments, Engagement Cloud Server (120) converts the screen content into a format that can be displayed on User Mobile Device (150). The content may be sent to a standard SMS inbox, or may be sent via formatted messages such that the mobile lottery SIM application (155) will display the messages to the user in Step 50020.

The mobile lottery SIM Application (155) displays the game play screens 6000, 6100, and 6200 via an interface shown in FIG. 7 and enables the collection of the user's response. In one example, a game play screen could appear as screen 6000 which reads:

“Win $250,000 Every Day! Play ABC Daily Lottery to get the chance to WIN the daily jackpot. You must be 18+ to play. Click to play . . . ” (6030). If the user clicks “Cancel” (6010), SIM Application (155) sends the user selection back to Engagement Cloud Server (120) and in Step 50030. Engagement Cloud Server (120) then sends this information to Gaming Engine Server (110) in Step 50040 and Gaming Engine Server (110) can store this information.

When the user clicks “Accept” (or a similar confirmation response) (6020), Gaming Engine (110) can be configured to allow the user to then select from a menu of different bundle options as shown in Game Play Screen 2 (6100). In some embodiments, the next screen appears with contents such as:
“Choose the number of games you want to play each day:
1×Game: $0.15
3×Game: $0.50
5×Game: $0.75
10×Game: $1.25” (6130) in FIG. 7 and in Step 50020 in FIG. 6

At Game Play Screen 2 (6100), the user can cancel via Cancel 6110 if, e.g., the user does not like the game choices presented. In some configurations, the user is asked to confirm his purchase. For example, after Accept 6120 is selected, a confirmation prompt could read: “Confirm Daily ABC Lottery subscription @ $0.15 per day for your chance to win $250,000 EVERY single day! Don't forget, you get 2 games for the price of 1! Ts & Cs at ABClottery.com.terms.” (6230) in FIG. 7. At Game Play Screen 2 (6200), the user can cancel via Cancel 6210. Once the user clicks “Accept”(6220), Engagement Cloud Server (155) will collect all of the information (how many games they would like to play per day) from the mobile lottery SIM Application (155) at step 50030 and send it to Gaming Engine Server (110) in step 50040.

As a myriad of game types are available, the system has the intelligence to store and recognize specific game preferences of a user over time and can automatically serve those suggestions to the user as the prominent game play options. In some embodiments, users may have the choice to subscribe to a daily, weekly, or monthly game type where the user is automatically entered into the game or drawing and charged accordingly, provided the user has sufficient balance or payment available.

Similarly, the system may be configured with a Contact Policy to limit the number of times a user sees offers for a specific game or is able to purchase a specific game. The Contact Policy may also be intelligently configured to show fewer gaming suggestions to the user if the user has repeatedly cancelled the gaming prompts. Users may also set their own Contact Policies by silencing the notifications for a specific period of time (for example, no notifications or prompts for 30 days).

### Second Chance Cancel Survey

If at any point, the user clicks “Cancel” (6010, 6110, 6210) in FIG. 7 on any of the game play screens 6000, 6100, or 6200, the mobile lottery SIM Application (155) sends the user's selection back to Engagement Cloud Server (120). Engagement Cloud Server (120) then sends this information to Gaming Engine Server (110) to be stored in Step 50040.

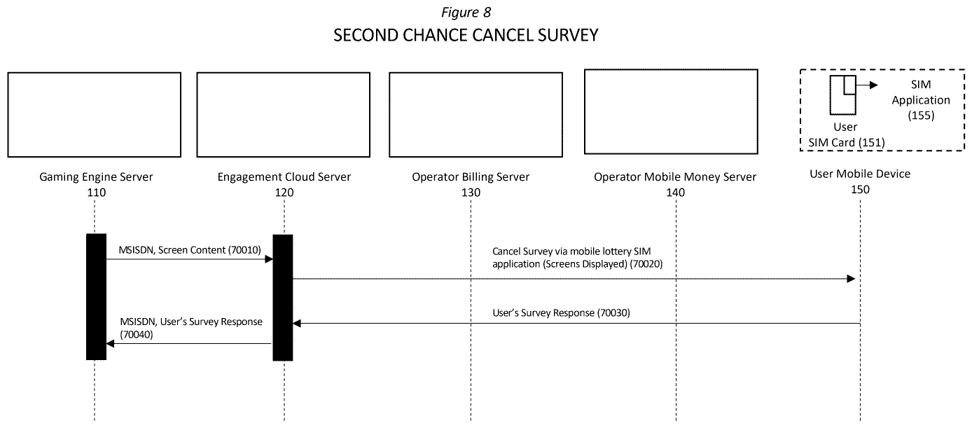

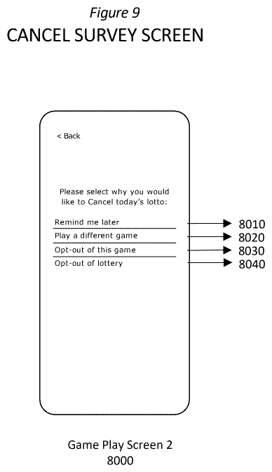

The mobile lottery service can be configured to collect additional intelligence about user preferences when a user decides to cancel the gaming journey in Step 70010 in FIG. 8. In one example, the service could be configured to display Game Play Screen 2 (8000) that reads:
“Please select why you Cancelled today's lotto:
Remind me later,
Play a different game,
Opt-out of lottery”. (8000) in FIG. 9 and in Step 70020 in FIG. 8

Once the user selects an option, the response is sent at step 70030 from the mobile lottery SIM Application (155) to Engagement Cloud Server (120) and is then subsequently sent to Gaming Engine Server (110) at step 70040. If the user selects “Remind me later” (8010) in FIG. 9, Engagement Cloud Server (120) can collect this information and send it to Gaming Engine Server (110). In some embodiments, the user is contacted again for the same game at a pre-configured time. If the user selects “Play a different game” (8020) in FIG. 9, then the user is presented with a screen with a selection of lottery games from which the user can choose. The system has the intelligence to remember the user's preferences and, in the future, the user will be presented with their preferred lottery selections or options similar to their preferred selections. “Opt-out of lottery” (8040) and “Opt-out of this game” (8030) in FIG. 9 follows a process similar to the opt-out user journey outlined in the before mentioned Recruitment process.

The Second Chance Cancel Survey is fully configurable and may be shown every time the user cancels a game play screen. In other embodiments, the Cancel Survey may only be displayed the first time the user selects “Cancel” within a specific game play user journey. The Cancel Survey could be shown only for specific lottery games, and not for others. Alternatively, the Gaming Engine can be configured to only display a Cancel Survey a predetermined number of times for a specific user either across all games the user chooses, or only across a specific set of games played. The Gaming Engine also has the intelligence to delay the Second Chance Cancel Survey screens such that they are “quieted,” or not displayed for a specific period of time (for example: 14 days).

### Opt-Out

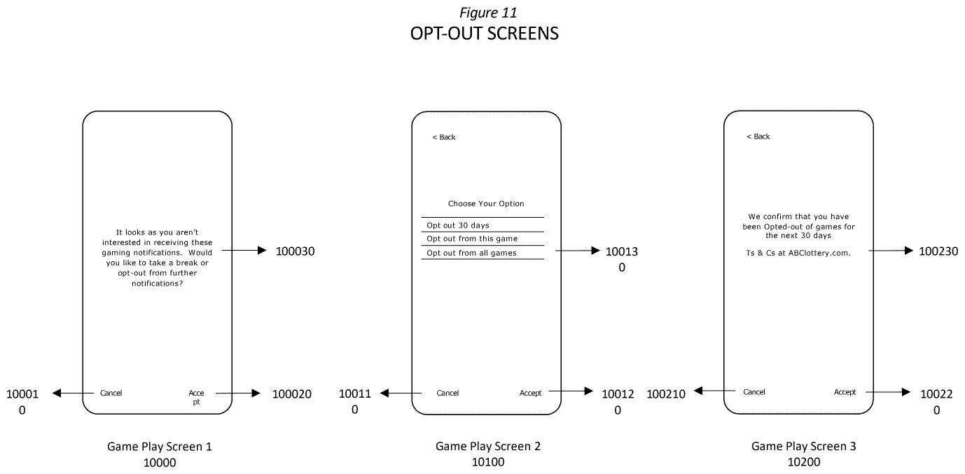

The system also has the intelligence to only continually target mobile users who have expressed interest in receiving game play promotions and notifications. If the user clicks “Cancel” on any prompt a specified number of times, the system can be configured to automatically ask the user if they would like to stop notifications or promotions for a specific game type, or for all games and lottery via screens 10000, 10100, and 10200. At step 90010, Gaming Engine Server (110) sends MSISDN and screen content to Engagement Cloud Server (120). At step 90020, Engagement Cloud Server (120) sends screen content to User Mobile Device (150). The mobile lottery SIM Application (155) displays a screen that reads, e.g., “It looks as if you aren't interested in receiving these gaming notifications. Would you like to take a break or opt-out from further notifications?” (100030) in FIG. 11. If user selects Cancel 100010, user's response is sent to Engagement Cloud Server (120) at step 90030 and the opt-out process can terminate. If the user clicks “Accept” (100020), in FIG. 11 the Gaming Engine (110) determines the next best action for the user based on preconfigured user journeys within the system. Gaming Engine Server (110) sends the notification to Engagement Cloud Server (102), which formats the message such that the mobile lottery SIM Application (155) can display the next set of screens to the user. In one example, the next screen with the Opt-out options could read as 100130 in FIG. 11:
“Please make a selection:
Opt-out for 30 days
Opt-out from this game
Opt-out of all games” (100130) in FIG. 11

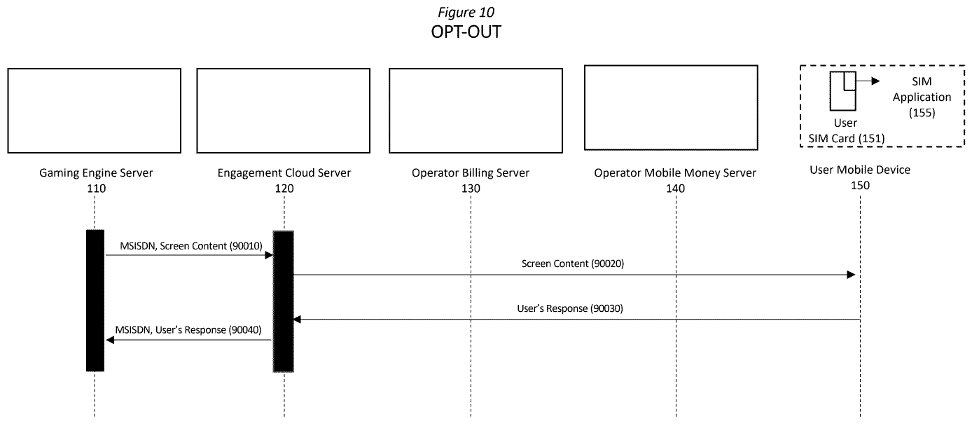

A user can select “Cancel” 100110 or selects one of the options displayed on screen 100130 and selects “Accept” 100120. Engagement Cloud Server (120) collects the user's chosen response, sent from SIM Application (155), and forwards it to Gaming Engine Server (110) to be stored in Step 90040 in FIG. 10. If the user clicks “Opt-out for 30 days,” the user will not be notified about any games or promotions for 30 days. “Opt-out from this game” will remove notifications for the specific game the user is currently playing, while “Opt-out of all games” stops all notifications about the lottery service. If a user clicks cancel at 100010, 100110, or 100210, the opt-out process terminates and the user is still eligible to be recruited by the system. After a selection is made on screen 10100, screen 10200 displays confirmation message 100230. The user can exit this screen by selecting “Accept” 100220 or canceling the opt-out by selecting “Cancel” 100210.

### Billing, User Payment

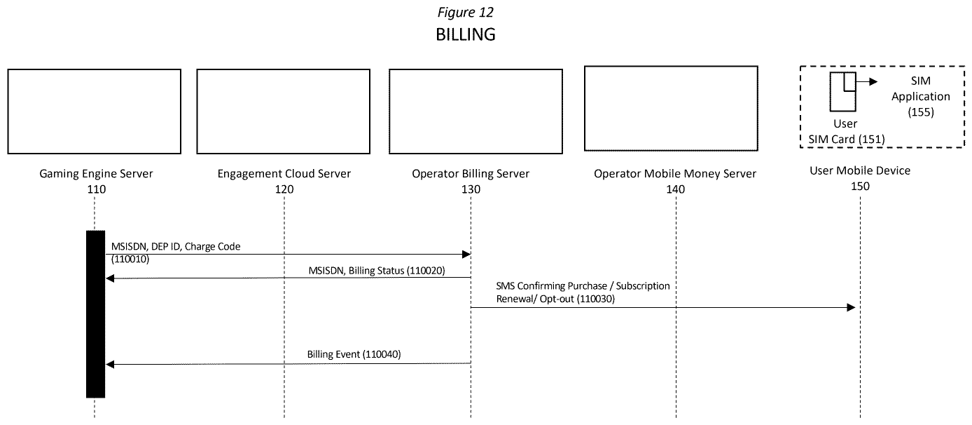

Once the game play selections are received from the user, Gaming Engine Server (110) sends the MSISDN and associated Game Charge Code to Operator Billing Server (130) in Step 110010 in FIG. 12. In some embodiments, Gaming Engine Server (110) sends this information to Engagement Cloud Server (120) which then sends it to Operator Billing Server (130). In some embodiments, Operator Billing Server (130) notifies Gaming Engine Server (110) that it has received the user's order. Gaming Engine Server (110) holds the order placement until it receives payment confirmation from Operator Billing Server (130) in Step 110020 in FIG. 12. In some embodiments, Operator Billing Server (130) sends an SMS message and informs the user about their purchase at step 110030. Gaming Engine Server (110) can also be configured to send a confirmation to the user (in some embodiments, sent via Engagement Cloud Server (120) and, in some embodiments, displayed to the user via SIM Application (155)). In one embodiment, message 12010 on Billing Screen 12000 reads “This confirms your $0.15 Daily Lottery daily game subscription. Brought to you by ABC Gaming. To cancel, send ‘STOP’ to 1234.”. Then, Operator Billing Server (130) sends the billing event to Gaming Engine Server (110) so Gaming Engine Server (110) has confirmation and can proceed. Information passed to the Gaming Engine can include parameters such as: Billing Amount, Date, Time, Transaction ID, Game Charge Code in Step 110040.

In some embodiments, a user may unsubscribe from game play at any time, which ceases any automated payments. Users may pay for the gaming options and/or tickets using a credit card, a mobile operator's mobile wallet application, a mobile money application or via mobile airtime. Providing users with a multitude of payment options increases game play specifically in regions where mobile users may not have credit cards or may be unbanked.

### Intelligent Billing, Lack of Sufficient Funds

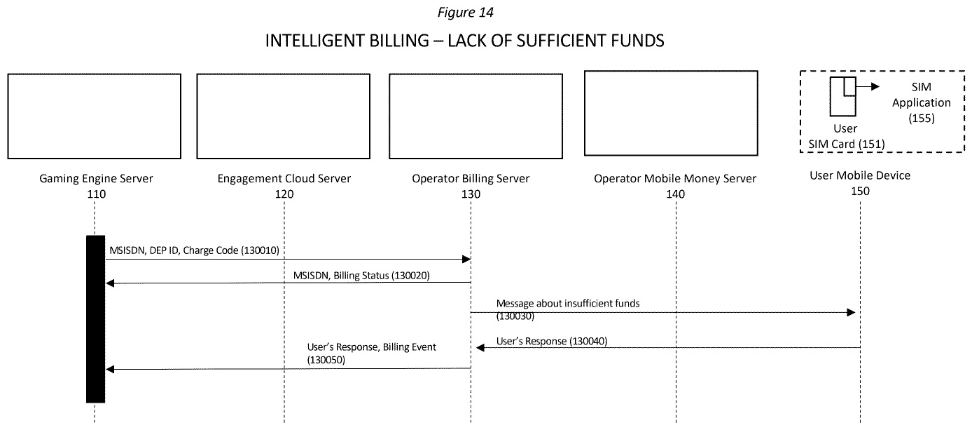

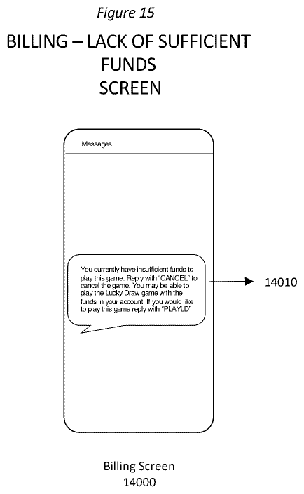

If a user selects a game but does not have sufficient funds to play the game, in some embodiments, Gaming Engine Server (110) has the intelligence to check the balance and to suggest a game option that can be purchased given the available balance. Gaming Engine Server (110) sends the MSISDN and charge code to Operator Billing Server (130) at step 130010. Charge code can include an amount to be charged to a user's account. Operator Billing Server (130) reports to Gaming Engine Server (110) that the user does not have sufficient funds in Step 130020 in FIG. 14. Gaming Engine Server (110) would then hold the order placement while Operator Billing Server (130) sends a message to the user in Step 130030 in FIG. 14 to inform them that they do not have sufficient funds to play that specific game. In some embodiments, this message reads “You currently have insufficient funds to play this game. Reply with “CANCEL” to cancel the game. You may play the Lucky Draw game with the funds in your account. If you would like to play this game reply with PLAY.” as shown by 14010 on Billing Screen 14000 in FIG. 15. Operator Billing Server (130) receives user's response in step 130040 and sends to Gaming Engine Server (110) at step 130050. The mobile lottery service intelligent billing feature provides the user the option to choose from a variety of other games that are within the user's funds allotment.

In other embodiments, the Gaming Engine may automatically attempt to purchase the lowest price option in the scenario where a user has insufficient funds for the initial selection (for example, one ticket is automatically purchased instead of a bundle of tickets for the same game). The user is then informed than an alternative purchase was made.

Gaming Engine Server (110) can also be configured to query Operator Billing Server (130) in the event that a user has insufficient funds. In this scenario, if an insufficient funds response is returned from Operator Billing Server (130), Gaming Engine Server (110) can query Operator Billing Server (130) to determine how much balance the user has. Based on the response, Gaming Engine Server (110) can intelligently suggest a new set of gaming options to the user, based on the available balance.

### Lottery Number Generation and User Notification

Once confirmation of payment is received at Gaming Engine Server (110) from Operator Billing Server (130) at 150010, lottery numbers for the user are selected. Lottery numbers can be generated at Step 150020 by the Gaming Engine Server (110), or Gaming Engine Server (110) can send a Get Input Box at 150030 to the mobile device so a user can input numbers. At 150040, Engagement Cloud Server (120) sends Get Input Box or lottery number options to User Mobile Device 150. At 150050, lottery numbers selected or values of numbers inputted on Mobile Device 150 are sent to Engagement Cloud Server (120). At 150055, Gaming Engine Server (110) receives a selection of numbers or inputted numbers. At 150060, Gaming Engine Server (110) sends a message confirming the chosen lottery numbers. Number selection may be completed using several different methods as explained herein. These methods could include:
Auto generation, where numbers are generated by the gaming system
User definition, where individual numbers are manually chosen by the user
or user selection from a menu, where the user chooses from a selection of auto generated number sets from a menu.

Gaming Engine Server (110) can be configured to offer the user a choice in how numbers are selected, or alternatively, can be configured to only allow number selection in a specific manner (for example, all numbers are auto generated by the system).

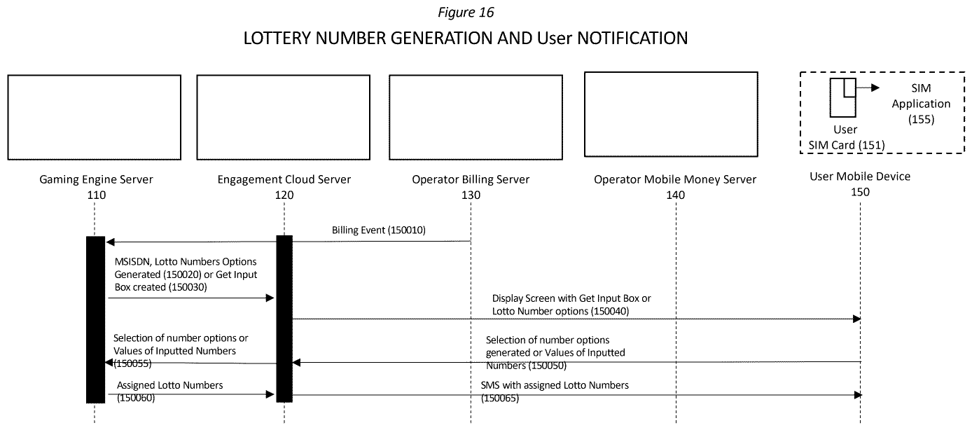

If the user has chosen to have game play numbers automatically generated, Gaming Engine Server (110) will randomly generate a set of playable numbers (Example: 04, 17, 36, 40, 45) for this user in Step 150020 and 150030 in FIG. 16.

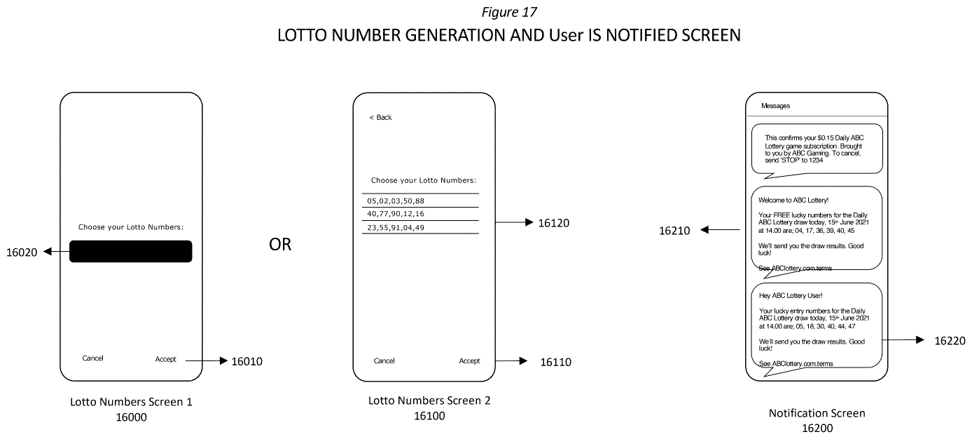

A user can see Lotto Number Screens 16000, 16100, and 16200 during lottery number selection. If the user chooses to select their own numbers individually for game play, they will be prompted by SIM Application (155) to enter their chosen numbers into a prompt within the mobile application screen (16020) in FIG. 17. In some embodiments, SIM Application (155) uses a “Get Input” command in order to display and collect this information. After inputting numbers, the user selects “Accept” 16010 to proceed. Gaming Engine Server (110) validates the numbers to ensure that appropriate number selections were entered. If the numbers are not valid, the user is notified and the user has another chance to correctly enter a set of chosen numbers for game play. In other embodiments, game play numbers may be collected via SMS or USSD.

In the scenario where the user chooses numbers for game play from a menu, the system can send the user multiple sets of numbers and displays these to the user via SIM Application (155) interface in a menu format. The user can review each of the sets, and select the number set they would like to use for play (16120) in FIG. 17. The user is able to review the number set and determine if they would like to keep the numbers or have the system generate a new set of numbers for game play in Step 150040. Once a selection of numbers is made, the user selects “Accept” 16110 to proceed.

Once the user selects numbers for game play using any of the beforementioned methods, Engagement Cloud Server (120) collects the user's response and sends it to the Gaming Engine Server (110). Gaming Engine Server (110) stores these lotto numbers (in this example: 04, 17, 36, 40, 45) in user's account. Gaming Engine Server (110) provides Engagement Cloud Server (120) with the user's MSISDN and assigned lotto numbers. Engagement Cloud Server (120) prepares and sends a message to the user at step 150065, which may be sent as a regular SMS or may be sent such that it is displayed via SIM Application (155) interface. The message includes the chosen lottery numbers for the user.

Gaming Engine Server (110) can be configured to display a set of confirmation messages to the user as shown in Notification Screen 16200. In some embodiments, the Gaming Engine has the intelligence to recognize that it is the first lottery game being played by the unique user. In this example, the system could be configured to allow award a free ticket for the first time user. The confirmation messages may read: “Welcome to ABC Lottery! Your FREE lucky numbers for the Daily ABC Lottery draw today, 15 Jun. 2021 at 14.00 are; 04, 17, 36, 40, 45. We'll send you the draw results. Good luck! See ABClottery.com.terms.” (16210) in FIG. 17. The second confirmation message could disclose the numbers for the game that the user purchased. This message could read “Hey ABC Lottery User! Your lucky entry numbers for the Daily ABC Lottery draw today, 15 Jun. 2021 at 14.00 are; 05, 18, 30, 40, 44, 47.” (16220) in FIG. 17.

### Winning Payout

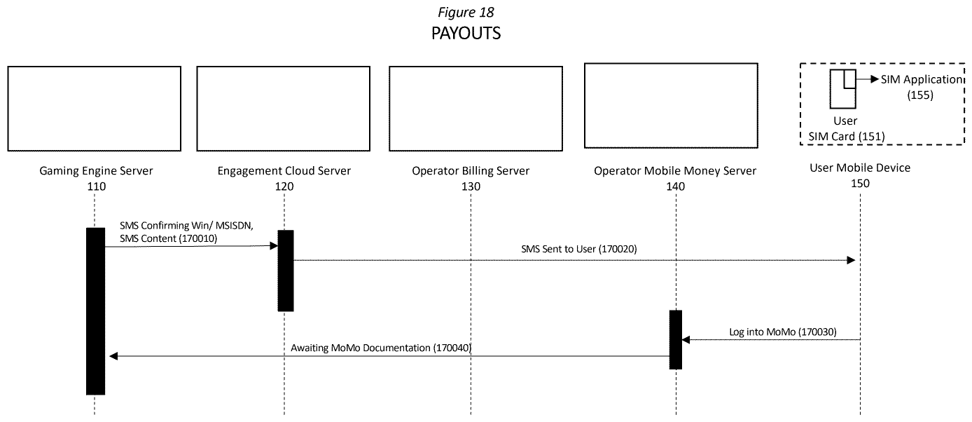

If a user wins a lottery game, Gaming Engine Server (110) in FIG. 18 provides the Engagement Cloud Server (120) with the winning content messages to display to the user in Step 170010. In some embodiments, Engagement Cloud Server (120) converts the content into proper formatting and sends an SMS message to User Mobile Device (150) at step 170020 in FIG. 18. The message displayed to the winning user is fully configurable and can be changed within Gaming Engine Server (110) at any time. Payout Screen 18000 shows notification message 18010 sent to the winning user which reads:

“Congratulations! Your numbers matched the winning numbers for today's Daily Draw. You have won $250. Please enter this code: KS45RT23 in your Mobile Money account to claim your prize. If you do not have a Mobile Money account, please click here to open a new account then enter this code to claim your prize. www.MNOmobilemoney.com.”

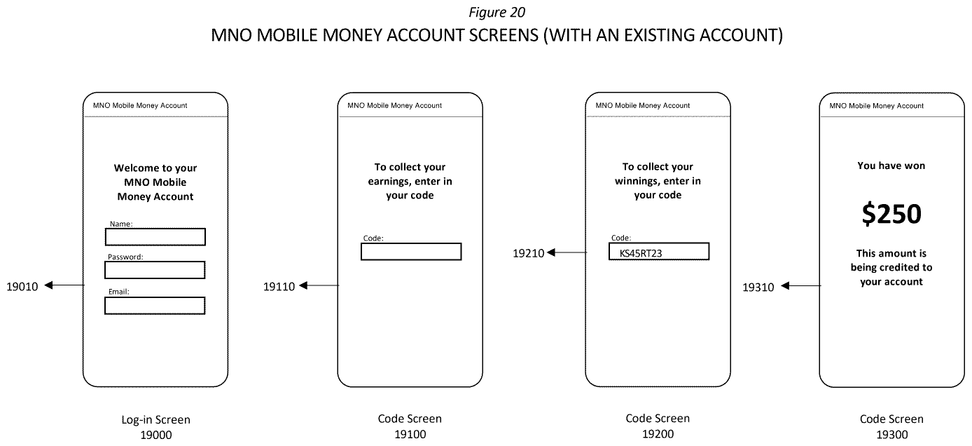

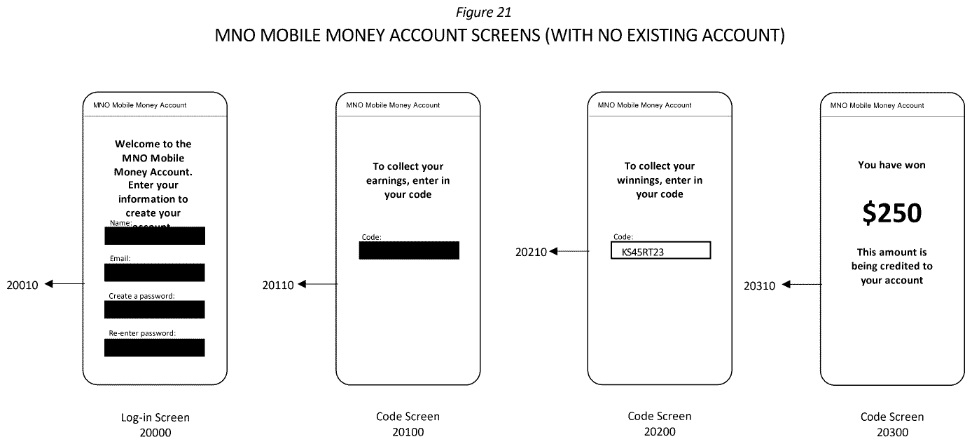

If the user has an existing Mobile Money account, the user can log into the account (19010) as shown in Log-In Screen 19000 and enter the code in box 19110 on Code Screen 19100 in FIG. 20 to claim their prize in Step 170030 in FIG. 18. If the user does not have an existing Mobile Money account, they can create a new account (20010) at Log-in Screen 20000 in FIG. 21 and then they enter the code at 20110 on Code Screen 20100 to claim their prize. Code Screens 19200 and 20200 show exemplary codes 19210 and 20210, respectively. Once entered, Code Screens 19300 and 20300 show prize amounts 19310 and 20310, respectively.

Once the code is entered, Mobile Operator Mobile Money Server (140) will deduct the winning amount from a Gaming Mobile Money account and credit the amount to the user's Mobile Money account in Step 170040 in FIG. 18 and as shown in Code Screens (19310, 20310) in FIG. 20 and FIG. 21.

While the invention has been particularly shown and described with reference to the embodiments illustrated in the drawings, it will be understood by one skilled in the art that various changes in detail may be affected therein without departing from the spirit and scope of the invention as defined by the claims.

1. A system for enabling game play of a lottery game on mobile device connected to a mobile operator's network comprising:
an Engagement Cloud Server operably connected to the mobile operator's network and configured to:
send a recruitment message to a plurality of mobile devices connected to the mobile operator's network, the recruitment message comprising:
an invitation to play a lottery game;
a first actionable option to accept the invitation; and
a second actionable option to decline the invitation,
wherein the recruitment message is configured to be displayed on a screen of a mobile device;
collect one or more responses to the recruitment message, wherein each response comprises a Mobile Station International Subscriber Directory Number (“MSISDN”) and an indication whether the first actionable option accepting the invitation or the second actionable option declining the invitation was selected on a mobile device associated with the MSISDN; and
send a communication to a Gaming Engine Server comprising a first MSISDN associated with a first mobile device and a first actionable option selected on the mobile device;
a Gaming Engine Server operably connected to the Engagement Cloud Server and the mobile operator's network, the Gaming Engine Server configured to:
send game content to the first mobile device, the game content comprising a game choice and a cost to play;
receive a response message comprising the first MSISDN of the first mobile device, game choice selected on the first mobile device, and mobile device lottery numbers selected on the first mobile device;
draw winning lottery numbers or retrieve winning lottery numbers from an established lottery;
determine whether the mobile device lottery numbers match the winning lottery numbers;
send a winning notification to the first mobile device if the mobile device lottery numbers match the winning lottery numbers, the winning notification comprising a prize amount; and
send the prize amount to an Operator Mobile Money Server an Operator Billing Server configured to:
access a mobile subscriber account associated with the first MSISDN;
determine whether the mobile subscriber account has sufficient funds to pay for the game choice selected on the first mobile device;
send a communication to the Gaming Engine Server or the Engagement Cloud server, or both, indicating the mobile subscriber account has sufficient funds to pay for the game choice selected on the first mobile device associated with the MSISDN; and
an Operator Mobile Money Server configured to receive a prize amount from the Gaming Engine Server and credit the prize amount to a prize account associated with the first MSISDN,
wherein the Engagement Cloud Server, Gaming Engine Server, Operator Billing Server, and Operator Mobile Money Server are operably connected to the mobile operator's network.

2. The system of claim 1, further comprising:
a mobile gaming application installed on a SIM of the first mobile device, the mobile gaming application configured to;
display content received from the Gaming Engine Server on a screen of the first mobile device;
receive an option selected on the screen of the first mobile device; and
send an application message comprising the option selected to the Gaming Engine Server.

3. A method for providing lottery gameplay to a mobile device in a gaming system comprising a gaming engine server, an engagement cloud server, an operator billing server, and an operator mobile money server, the mobile device and the gaming system being operable connected to a mobile operator's network, the method comprising the steps of:
sending, from the engagement cloud server, a recruitment message to be displayed on a screen of a mobile device, the recruitment message comprising an invitation to play a lottery game and an actionable option to accept the invitation;
sending, from the engagement cloud server to the gaming engine server, a communication comprising the MSISDN of the mobile device;
sending, from the gaming engine server to the mobile device, a first gaming message comprising a game choice and a cost to play;
upon receipt of a game choice selected on the mobile device, sending, from the gaming engine server to the mobile device, a second gaming message comprising an option to input lottery numbers and an option to select lottery numbers;
upon receipt of inputted or selected lottery numbers, sending, from the gaming engine server to the mobile device, a confirmation message comprising contents confirming the inputted or selected lottery numbers and the cost to play;
at the gaming engine server, generating winning lottery numbers or retrieving winning lottery numbers from an established lottery; and
determining whether the inputted or selected lottery numbers match the winning lottery numbers.

4. The method of claim 3, further comprising:
sending, from the gaming engine server to the operator billing server, an inquiry to determine sufficiency of funds to pay the cost to play;
determining, at the mobile operator billing server, whether a mobile account associated with the mobile device has sufficient funds to pay the cost to play; and
sending, from the mobile operator billing server to the gaming engine server, a funds confirmation message indicating the mobile account has sufficient funds to pay the cost to play.

5. The method of claim 3, further comprising:
sending a notification from the gaming engine server to the mobile device indicating the inputted or selected lottery numbers match the winning lottery numbers and a prize amount; and
sending, from the gaming engine server to an operator mobile money server, the prize amount to be credited to a prize account associated with the mobile device.

6. The method of claim 3, further comprising the step of executing a self exclusion process wherein the engagement cloud server receives a self exclusion message from the mobile device, and the engagement cloud server sends the MSISDN of the mobile device and the response to the gaming engine server.

7. The method of claim 3, further comprising the step of providing a second chance cancel survey by executing the following steps:
receiving the MSISDN of the mobile device and screen content from the gaming engine server at the engagement cloud server;
sending a cancel survey from the engagement cloud server to the mobile device;
receiving a user's survey response from the mobile device at the engagement cloud server; and
sending the MSISDN of the mobile device and the user's survey response from the engagement cloud server to the gaming engine server.

8. The method of claim 3, further comprising providing an opt-out process by executing the following steps:
receiving the MSISDN of the mobile device and screen content from the gaming engine server at the engagement cloud server;
sending screen content from the engagement cloud server to the mobile device;
receiving an opt-out response at the engagement cloud server, wherein the opt-out response indicates that the mobile device should not be contacted about lottery gameplay; and
transmitting the MSISDN and the user's response from the engagement cloud server to the gaming engine server.

9. The method of claim 3, further comprising the step of executing a billing process by executing the following steps:
receiving the MSISDN of the mobile device, unique ID, and charge code from the gaming engine server at the operator billing server;
transmitting the MSISDN of the mobile device and billing status to the gaming engine server from the operator billing server;
sending a SMS message confirming purchase from the operator billing server to the mobile device; and
communicating a billing event from the operator billing server to the gaming engine server.

10. The method of claim 3, further comprising executing an intelligent billing process in the event of lack of sufficient funds by executing the following steps:
receiving MSISDN of the mobile device, unique ID, and charge code from the gaming engine server at the operator billing server;
communicating the MSISDN of the mobile device and the billing status from the operator billing server to the gaming engine server;
transmitting a SMS regarding insufficient funds from the operator billing server to the mobile device;
receiving a funds response from the mobile device at the operator billing server, wherein the funds response comprises a selection of an alternative game choice; and
sending the funds response and billing event from the operator billing server to the gaming engine server.

11. The method of claim 3, further comprising the step of executing a lottery number generation and player notification process comprising the following steps:
sending a billing event from the operator billing server to the gaming engine server;
transmitting the MSISDN of the mobile device, lotto numbers options generated, or Get Input Box generated from the gaming engine server to the mobile device;
sending instructions for presenting a display screen with Get Input Box or Lotto Number options by communicating information from the engagement cloud server to the mobile device;
receiving a selection of number options generated or values of inputted numbers at the gaming engine server from the mobile device;
sending assigned lotto numbers from the gaming engine server to the engagement cloud server; and,
transmitting a SMS message with assigned lotto numbers from the engagement cloud server to the mobile device.

12. The method of claim 3, wherein the step of receiving a selection of number options generated or values of inputted numbers at the gaming server from the mobile device comprises receiving a selection of numbers options generated or values of inputted numbers from the engagement cloud server.

13. The method of claim 3, further comprising the step of a executing a payout process, wherein the payout process comprises the following steps:
sending a SMS message confirming a win, MSISDN of the mobile device, and a SMS content from the gaming engine server to the engagement cloud server;
communicating a SMS message confirming win from the engagement cloud server to the mobile device;
granting access to the operator mobile money server to the mobile device; and
sending a request for a prize amount from the operator mobile money server to the gaming engine server.

14. The method of claim 3, further comprising the step of presenting mobile money account screens with an existing account to the mobile device.

15. The method of claim 3, further comprising the step of presenting mobile money account screens without an existing account to the mobile device.

16. The method of claim 3, further comprising the step of executing the steps of the method by executing instructions stored on a SIM application on a User SIM card.

17. A gaming system for providing a lottery to a mobile device, the gaming system comprising:
a gaming engine server;
an engagement cloud server, wherein the engagement cloud server is communicatively coupled to the gaming engine server to receive game content;
an operator billing server, wherein the operator billing server is communicatively coupled to the engagement cloud server, and
an operator mobile money server, wherein the operator mobile money server is communicatively coupled to the mobile device.

18. The system of claim 17, wherein the engagement cloud server is configured to convert screen content into a format that may be displayed on the mobile device.

19. The system of claim 17, wherein the operator billing server is configured accept payments from a mobile device for mobile gaming subscriptions.

20. The system of claim 17, wherein the operator billing server is configured to check accounts for mobile device users to permit ad hoc or automated withdrawals.

21. The system of claim 17, wherein the operator mobile money server is configured to store prizes that are won by the user of the mobile device.
